(19) United States
(12) Patent Application Publication
(10) Pub. No.: US 2026/0244552 A1
(43) Pub. Date: Aug. 20, 2026

(54) Generation of User Interface Formalized Procedures from Identified Ad Hoc Procedures

(71) Applicant: ServiceNow, Inc., Santa Clara, CA (US)

(72) Inventors: Aaron Liebling, Santa Fe, NM (US); Jan Ove Kristian Olsson, Santa Clara, CA (US); Min Wu, Pleasanton, CA (US); Fabio Casati, Pedrinate (CH)

(21) Appl. No.: 19/058,737

(22) Filed: Feb. 20, 2025

(51) Int. Cl. G06F 11/34

(52) U.S. Cl. CPC G06F 11/3476; G06F 11/3447

(57) ABSTRACT

An example implementation involves: obtaining a log of events, wherein the events include changes to a software platform due to performance of a procedure, and interface actions received by the software platform while performing the procedure; identifying, by way of a machine learning model, clustered sequences of the events related to nominal performance of the procedure and non-nominal performance of the procedure; determining, from the clustered sequences, one or more particular sequences of the events for formalization of the procedure; and generating, from the one or more particular sequences of the events, a workflow or contextual guidance that formalizes the procedure.

### BACKGROUND

Modern applications often include sets of pages (e.g., web pages) that are displayed to users in a particular order so that the users can interact with the applications in a proscribed fashion. In some cases, these pages and their ordering is formalized as a workflow. In other cases, the users tend to navigate through the pages in a particular order, but determine this order an ad hoc fashion. When users interact with one or more applications in accordance with such an ad hoc procedure, it is an indicator that a software platform hosting the applications may be subject to wastage of computing resources (e.g., processing, memory, network, and power capacity).

### SUMMARY

When users identify ad hoc procedures that they find useful, they tend to follow these procedures to navigate through one or more applications. In other words, an ad hoc procedure may not have been explicitly considered or defined by designers of the applications, but users have found – likely through trial and error – that these procedures are suitable to their needs. Such ad hoc procedures are typically not forced on the users, and therefore the users might not follow them in exactly the same fashion each time. Furthermore, less experienced users who are attempting to solve a problem or reach a goal by way of the applications may take time exploring dead end possibilities before settling on the ad hoc procedures. This additional navigation requires page loads, database accesses, and user interface rendering that drives up the usage of computing resources as users explore these possibilities.

Frequently used ad hoc procedures can be identified by way of audit log and user interface log analysis. Once an ad hoc procedure is identified, the logs can also be examined to determine how often the procedure is performed nominally (e.g., in a direct fashion from a logical starting point to a logical ending point) and non-nominally (e.g., failing to complete, taking a circuitous path, or causing performance or security issues). At least some of these ad hoc procedures can be selected for conversion to formal workflows and/or for enhancement with contextual guidance. Doing so serves to guide the users toward nominal performance of the procedures, thereby reducing wasted computing resources.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. A method according to a general aspect includes obtaining a log of events, where the events include changes to a software platform due to performance of a procedure, and interface actions received by the software platform while performing the procedure. The method also includes identifying, by way of a machine learning model, clustered sequences of the events related to nominal performance of the procedure and non-nominal performance of the procedure. The method also includes determining, from the clustered sequences, one or more particular sequences of the events for formalization of the procedure. The method also includes generating, from the one or more particular sequences of the events, a workflow or contextual guidance that formalizes the procedure. Other embodiments of this aspect include corresponding computer systems, apparatus, and computer programs recorded on one or more computer storage devices, each configured to perform the actions of the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 is a flow chart for identification and generation of workflows and/or guided tours, in accordance with example embodiments.

FIG. 7 depicts an audit log, in accordance with example embodiments.

FIG. 8 depicts a user interface interaction log, in accordance with example embodiments.

FIG. 9 depicts combined log, in accordance with example embodiments.

FIG. 10 depicts a workflow definition file derived from a combined log, in accordance with example embodiments.

FIG. 11 depicts a guided tour definition file derived from a combined log, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I.Example Technical Improvements

These embodiments provide a technical solution to a technical problem. One technical problem being solved is wastage of computing resources due to incorrect, incomplete, inefficient, and/or insecure performance of computer-mediated procedures. In particular, a software platform can automatically determine when certain ad hoc procedures might benefit from formalization as a workflow or with a guided tour.

Properly designed workflows and guided tours are inherently a technical improvement to software platforms. When users attempt to follow a procedure though a web-based form or other mechanism, they can easily become confused based on the minimal instructions provided by the form or the software platform in general. Thus, utilization of workflows and guided tours result in less wastage of computing resources because users are unlikely to become confused or lost, retrace their steps, or redo parts or all of a workflows or guided tours. Since each user interaction with a web page or component thereof (e.g., each user interface data entry or “click”) consumes computing resources to respond to the user’s input, reducing these interactions increases software platform resource efficiency.

Further to that point, guided tours reduce the need for resource-heavy support systems by embedding real-time, context-sensitive guidance directly within the platform. Traditional help systems, such as external training sessions, knowledge base lookups, or live customer support interactions, require significant server and network resources for hosting, searching, and responding to user queries. By contrast, guided tours are implemented as lightweight, client-side overlays that rely on pre-configured metadata and event-driven interactions. These tours operate locally within the user’s session, using existing data on the client side, thereby reducing server load and network traffic.

Other technical improvements may also flow from these embodiments, and other technical problems may be solved. Thus, this statement of technical improvements is not limiting and instead constitutes examples of advantages that can be realized from the embodiments.

### II.Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise’s ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise’s operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise’s custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise’s network and used to manage such a network. The following embodiments describe architectural and functional aspects of example aPaaS systems, as well as the features and advantages thereof.

### III.Example Computing Devices and Cloud-Based Computing Environments

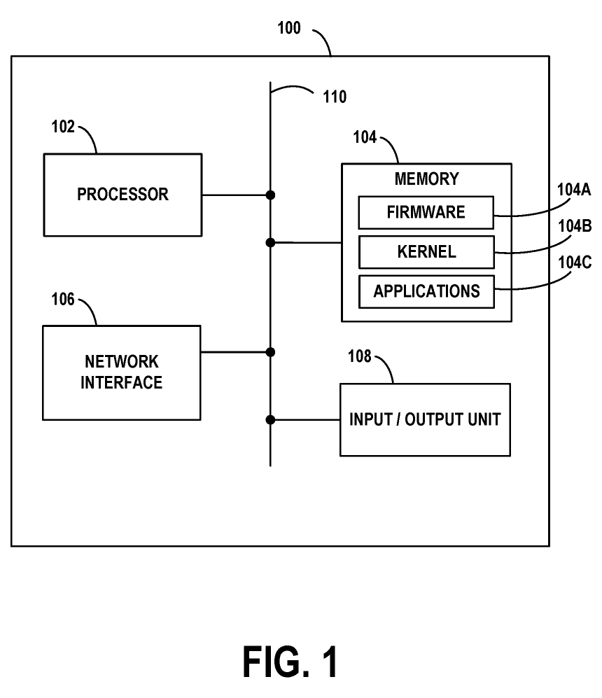

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input / output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input / output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input / output unit 108 may facilitate user and peripheral device interaction with computing device 100. Input / output unit 108 may include one or more types of input devices, such as a keyboard, a mouse, a touch screen, and so on. Similarly, input / output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

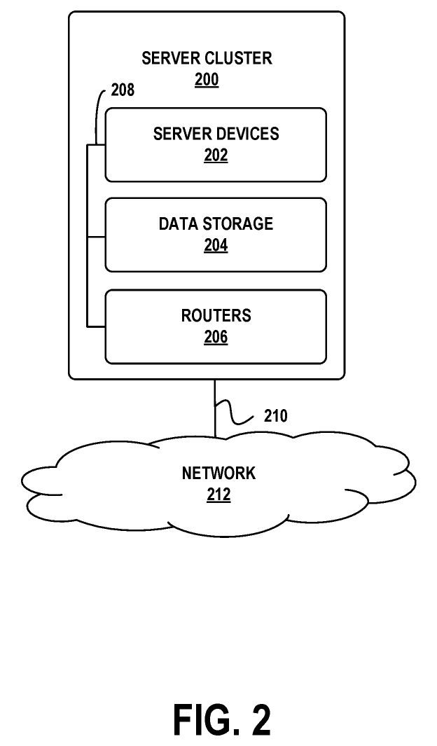

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV.Example Remote Network Management Architecture

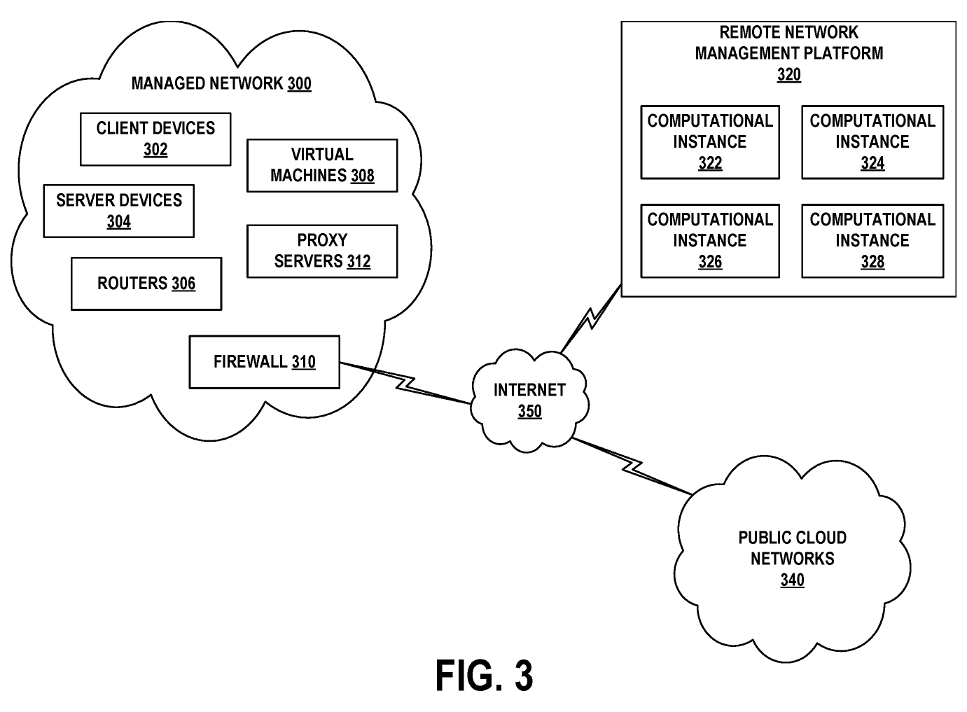

FIG. 3 depicts a remote network management architecture, in accordance with example embodiments. This architecture includes three main components – managed network 300, remote network management platform 320, and public cloud networks 340 – all connected by way of Internet 350.

### A.Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B.Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers’ data are separate from one another, the separation is enforced by the software that operates the single database. As a consequence, a security breach in this system may affect all customers’ data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer’s instance experiences an outage due to errors or an upgrade, other computational instances are not impacted. Maintenance down time is limited because the database only contains one customer’s data. Further, the simpler design of the multi-instance architecture allows redundant copies of each customer database and instance to be deployed in a geographically diverse fashion. This facilitates high availability, where the live version of the customer’s instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C.Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D.Communication Support and Other Operations

Internet 350 may represent a portion of the global Internet. However, Internet 350 may alternatively represent a different type of network, such as a private wide-area or local-area packet-switched network.

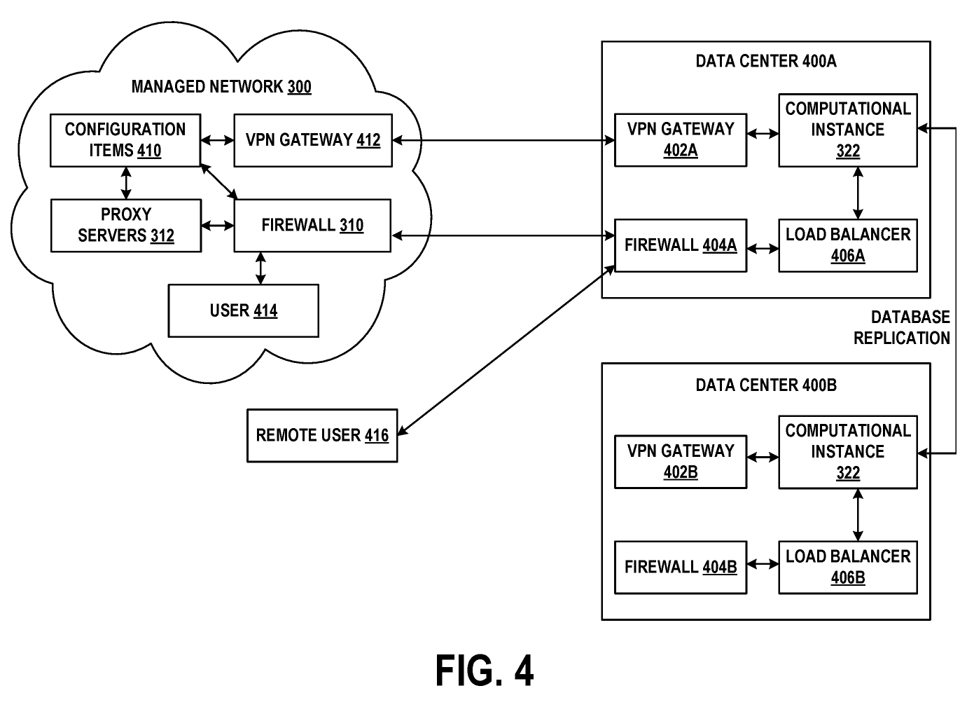

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0 – 10.255.255.255 or 192.168.0.0 – 192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V.Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

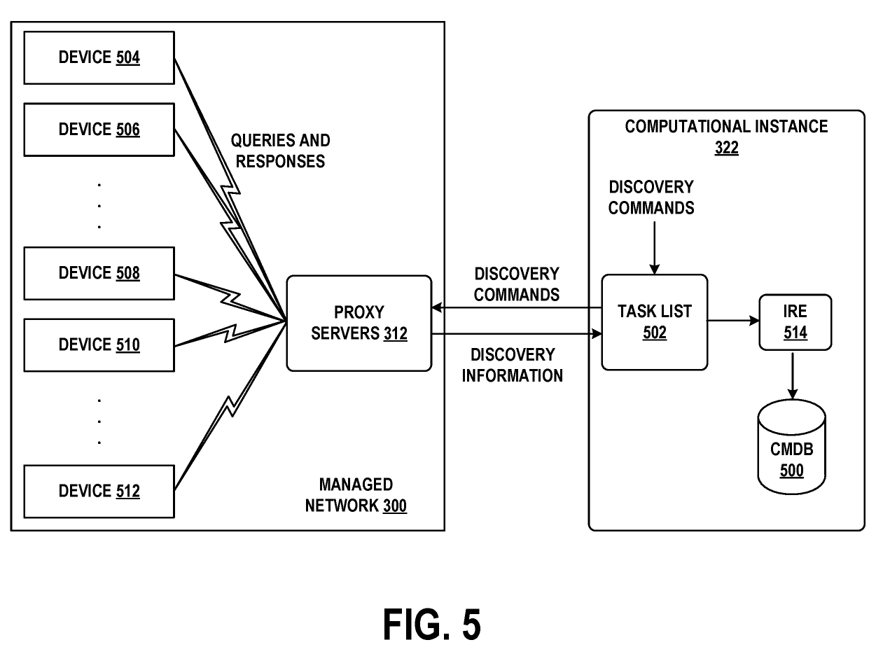

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid / password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery – horizontal and vertical (top-down). Each are discussed below.

### A.Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input / output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router’s network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases – under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B.Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices – for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C.Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI.CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item’s attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII.Generation of Workflows and Guided Tours

The embodiments herein involve the generation of workflows and/or guided tours from observed user behavior on a software platform. The workflows and guided tours may be represented as data and/or programmatically, and the software platform (or another computing system) may be able to display each type visually (e.g., on a user interface) as a way of guiding subsequent users through identified procedures.

A workflow, sometimes referred to as a playbook, is a structured, sequence of activities designed to streamline repetitive sequences of steps relating to software-facilitated procedures. These may involve incident resolution, case management, task management, onboarding, offboarding, and so on.

A workflow operates as a state machine, utilizing a combination of stages, transitions, and activities. It is initiated by specific triggers, such as changes to a database entry, a user action, or an internal or external system event. Each workflow is defined by a series of nodes representing discrete actions or logic. These nodes include predefined activities (e.g., sending notifications, updating records, or executing scripts), decision logic for conditional branching, and sub-flows for reusable process fragments. The transitions between nodes are often managed based on conditions.

Workflows may utilize database and scripting frameworks of remote network management platform 320. Each workflow may be associated with a context table that tracks the state of its execution, including the current stage, associated database entries, variables, and execution history. Variables, both input and output, can be passed between workflow stages, enabling data to persist and transform throughout the workflow’s lifecycle. Custom scripts can be incorporated into workflows to extend functionality, such as integrations with external systems via REST or SOAP APIs. A workflow’s execution can be monitored and logged, providing an audit log of actions taken.

In some cases, workflows may support guiding users through a visually interactive, step-by-step process while automating repetitive tasks. This can enhance user productivity and provide faster times to resolution of issues and problems.

In contrast, a guided tour is an interactive, step-by-step, in-platform training and assistance feature that provides users with contextual guidance on how to use various functionalities of the platform and its user interfaces. It is designed as an overlay system that dynamically interacts with an underlying user interface to walk users through specific tasks, processes, or features in real-time.

Guided tours can be implemented as configurable frameworks built on remote network management platform 320, employing client-side technologies such as JavaScript, HTML, and CSS to render the interactive overlays. Each tour consists of a sequence of steps, where each step corresponds to a specific user interface element or action on a web page. These steps are configured to highlight the relevant user interface component (such as a text box, button, or menu item) and display a tooltip or instruction bubble containing textual guidance, multimedia elements, or links for additional resources. Herein the terms component and element may both refer to any type of object appearing on or related to a user interface.

Guided tours can use the document object model (DOM) of a web page to identify and interact with user interface elements. This is achieved by referencing unique DOM selectors or custom attributes assigned to user interface components. Each step in the tour can be associated with triggers and validations, ensuring that the user completes a required action, such as filling out a field or clicking a button, before proceeding to the next step. The tour framework also includes support for conditional branching, allowing the flow of the tour to adapt dynamically based on user input or system state.

The underlying metadata for each tour can be stored in database tables, enabling versioning, audit trails, and reuse across different pages or applications. Advanced scripting capabilities are available for developers to add custom logic or behaviors to guided tours.

Properly designed workflows and guided tours are inherently a technical improvement to software platforms. When users attempt to follow a procedure though a web-based form or other mechanism, they can easily become confused based on the minimal instructions provided by the form or the software platform in general. Thus, utilization of workflows and guided tours result in less wastage of computing resources because users are unlikely to become confused or lost, retrace their steps, or redo parts or all of a workflows or guided tours. Since each user interaction with a web page or component thereof (e.g., each user interface data entry or “click”) consumes computing resources to respond to the user’s input, reducing these interactions increases software platform resource efficiency.

Further to that point, guided tours reduce the need for resource-heavy support systems by embedding real-time, context-sensitive guidance directly within the platform. Traditional help systems, such as external training sessions, knowledge base lookups, or live customer support interactions, require significant server and network resources for hosting, searching, and responding to user queries. By contrast, guided tours are implemented as lightweight, client-side overlays that rely on pre-configured metadata and event-driven interactions. These tours operate locally within the user’s session, using existing data on the client side, thereby reducing server load and network traffic.

As another example, workflows and guided tours utilize contextual awareness to adapt their behavior dynamically, reducing unnecessary computation. Guided tours only load and execute steps relevant to the user’s current page or task. This selective activation reduces the memory footprint and avoids preloading irrelevant components or instructions. Workflows can conditionally execute actions based on real-time data, user inputs, or system states. By skipping unnecessary steps or terminating prematurely when conditions are met, the software platform avoids executing redundant operations and conserves processing power.

Typically, workflows and/or guided tours are developed only for certain procedures – usually well-defined procedures. However, users of a software platform may engage in many other procedures, including ad hoc procedures that designers of the software platform did not explicitly consider and/or do not appear in any system documentation, that could benefit from workflows and/or guided tours. Thus, one possible goal of the embodiments herein is to identify what procedures users tend to follow in practice, and then determine whether any of those procedures might benefit from workflows and/or guided tours. For example, these procedures might be related to incident management, change management, problem resolution, robotic process automation, cloud resource provisioning, file transfer, onboarding, offboarding, machine learning model deployment and execution, and so on.

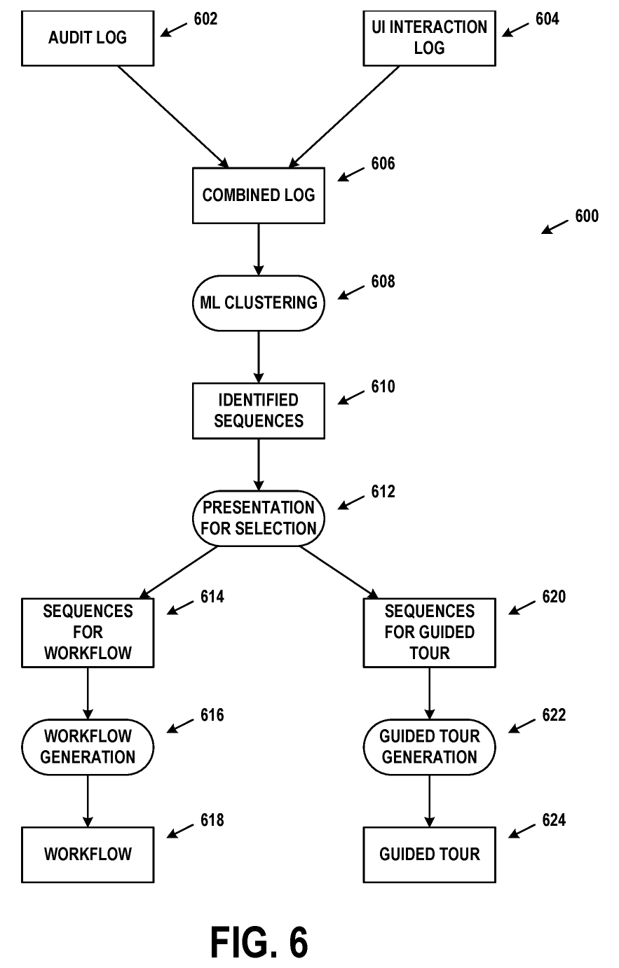

FIG. 6 is a flow chart 600 for identification and generation of workflows and/or guided tours. FIG. 6 will first be described generally and then each step and the data it operates on will be described in more detail. Note that, by convention, FIG. 6 depicts data in rectangles with squared corners and processing steps in rectangles with rounded corners.

Audit log 602 is data that tracks and records changes made to a software platform, particularly to fields of certain specified database tables. User interface (UI) interaction log 604 records how users interact with a user interface, including page loads, option selections (e.g., from a menu or list), component actuations (e.g., clicks, selections, button presses), and so on. Both audit log 602 and UI interaction log 604 may record each event with a corresponding timestamp of when that even occurred.

Combined log 606 includes data from both audit log 602 and UI interaction log 604. Thus, combined log 606 represents timestamped sequences of events relating to user activities and changes to the software platform related to this user activity. These sequences of events can be further processed (mined) to determine ad hoc procedures that one or more users of the software platform are following.

Machine learning (ML) clustering step 608 takes combined log 606 as input and then determines and clusters these sequences of events. Certain of these sequences may be identified “of interest” such as being commonly used, exhibiting frequent errors, being inefficiently performed, or lacking completion. This results in identified sequences 610.

Presentation for selection step 612 is an optional activity that involves displaying representations of one or more of identified sequences 610 to a user on a graphical user interface for review. The user may select any of identified sequences 610 that are displayed, further modify, edit, or document the sequence, and then indicate that a workflow, guided tour, or both should be generated for this sequence.

Thus, sequences for workflow 614 may be produced. After optional formatting for compatibility with a workflow generator, they may be provided as input to the workflow generator at workflow generation step 616. The output of workflow generation step 616 may be workflow 618, which can be deployed on a software platform.

Likewise, sequences for guided tour 620 may be produced. After optional formatting for compatibility with a guided tour generator, they may be provided as input to the guided tour generator at guided tour generation step 622. The output of guided tour generation step 622 may be workflow 624, which can be deployed on a software platform.

In this fashion, workflows and guided tours can be integrated into a software platform based on empirical evidence of their value and/or need. The following subsections provide more detail on each of these types of data and processing steps.

### A.Audit Logs

As noted, audit log 602 may be data that tracks and records changes made to a software platform ordered by timestamps of when each of these events occurred. Audit log 602 and its related software may be configured to only record changes to particular database tables or to particular fields of specified database tables. In general, an audit log could be many megabytes or gigabytes in size, and some procedures may span more than one audit log.

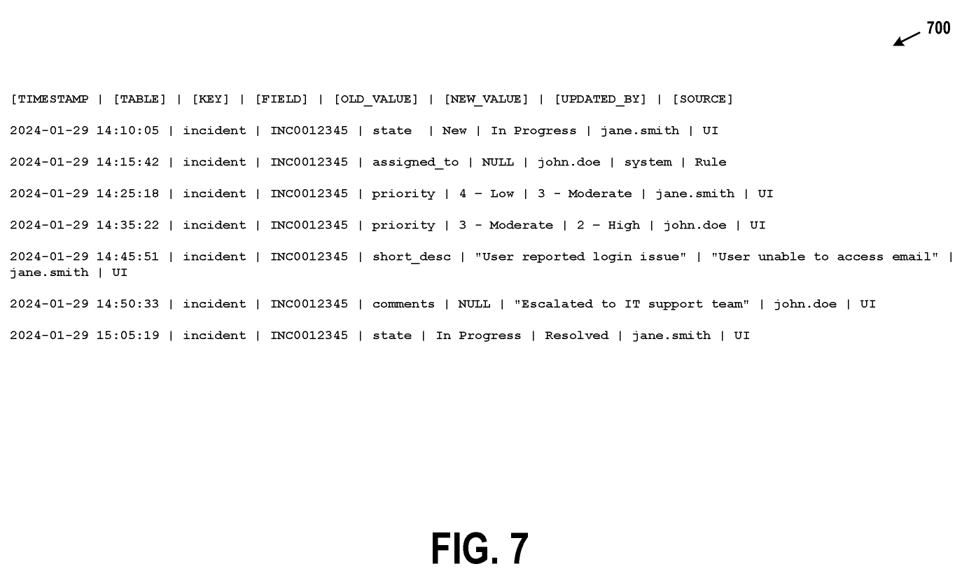

FIG. 7 depicts an example audit log. Particularly, audit log excerpt 700 may be a subset of entries from audit log 602. Notably, audit log 602 may contain a number of interleaved events from different procedures being followed by different users and applications, while audit log excerpt 700 displays entries from just one procedure.

Particularly, audit log excerpt 700 depicts the lifecycle of an incident from being opened in a new state to being resolved. In between, users and/or application software may change values of its fields. In the example of audit log excerpt 700, the following changes are made and logged. 14:10:05 - state changed from New to In Progress by jane.smith via user interface (UI). 14:15:42 - assigned_to field updated by assigning john.doe. 14:25:18 - priority changed from 4 - Low to 3 - Moderate. 14:35:22 - priority escalated further to 2 - High by john.doe. 14:45:51 - short_description edited to reflect a more accurate issue. 14:50:33 - comments field updated to indicate escalation. 15:05:19 - state changed to Resolved by jane.smith.

Notably, the procedure of audit log excerpt 700 has a clear starting point (the first entry changing the state of the incident from New to In Progress) and a clear ending point (the last entry changing the state of the incident from In Progress to Resolved). Not all procedures will have readily identifiable and logical starting and ending points in an audit log.

In many cases, these may be at least some of the procedures of interest because users may be unclear as to their navigation. For example, a procedure that frequently lacks a logical ending point in audit logs may be one that users find confusing and are often unable to navigate successfully to a logical conclusion.

### B.UI Interaction Logs

As noted, UI interaction log 604 may be data that tracks and records user interactions with user interface components ordered by timestamps of when each of these events occurred. UI interaction log 604 and its related software may be configured to only record interactions with certain user interface components and/or related activities. Like an audit log, a UI interaction log could be many megabytes or gigabytes in size, and some procedures may span more than one UI interaction log.

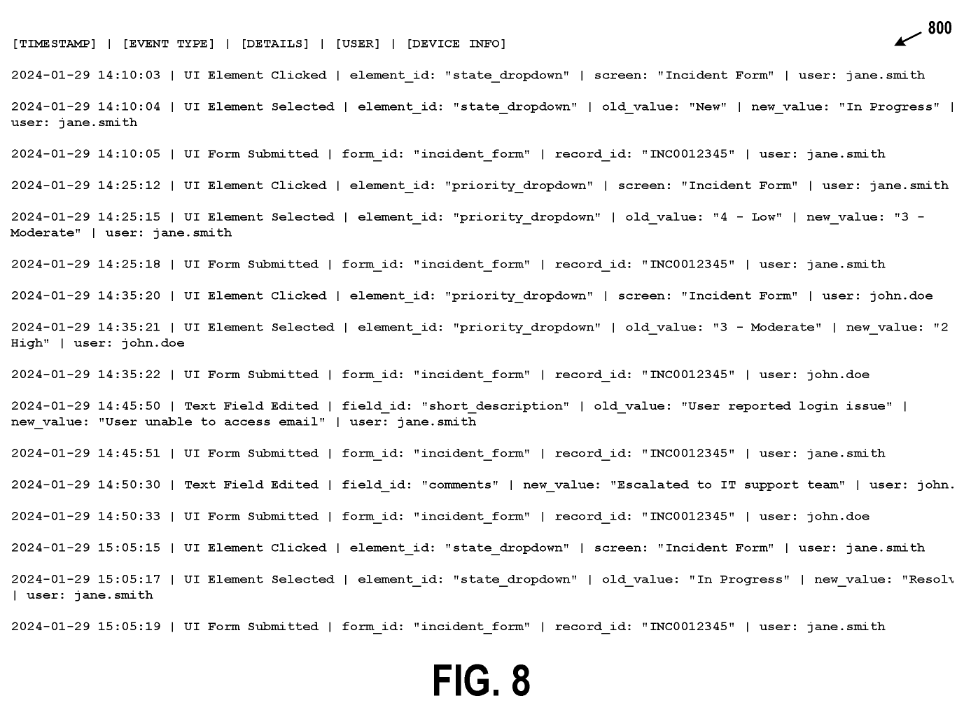

FIG. 8 depicts an example UI interaction log 800. Particularly, UI interaction log 800 may be a subset of entries from UI interaction log 604. Notably, UI interaction log 604 may contain a number of interleaved UI-related events from different procedures being followed by different users and applications, while UI interaction log 800 displays entries from just one procedure.

UI interaction log 800 contains a number of events that can be considered a sequence relating to the handling of an incident. User interactions with user interface components include the following. UI Element Clicked - logs when a dropdown, button, or field is clicked. UI Element Selected - tracks changes to dropdowns or selection menus. Text Field Edited - captures changes in text fields (short description, comments). UI Form Submitted - indicates that an update was saved to storage (e.g., data entered in the updated form is written to a database). Alternatively, each individual user interface interaction with a specific component may be considered a discrete sequence. For example, the first three entries in UI interaction log 800 may be considered a sequence (one that involves the selection of a new value from a dropdown menu and the subsequent submission of the form with new value.

Thus, the procedure of UI interaction log 800 may have several clear starting points (the user’s initial interaction with a user interface component) and clear ending points (the user causing a form to be submitted). But not all procedures will have readily identifiable and logical starting and ending points in a UI interaction log.

In some cases, these may represent procedures of interest. For example, a procedure that frequently lacks a logical ending point in UI interaction logs may be one that users find confusing. Thus, some users may be unable to use these procedures to navigate successfully to a logical conclusion (e.g., they forget or otherwise fail to cause a form to be submitted after making changes to a form). The lack of such an ending point may be inferred when the interactions of a particular user or set of users end without reaching a nominal (e.g., predefined) ending point.

### C.Combined Logs

Combined log 606 represents a merging of audit log 602 and UI interaction log 604. This merging may be an interleaving of events from audit log 602 and UI interaction log 604 based on their respective timestamps so that the events are time-ordered in combined log 606. In some cases, filtering of events may occur before or after this merging takes place.

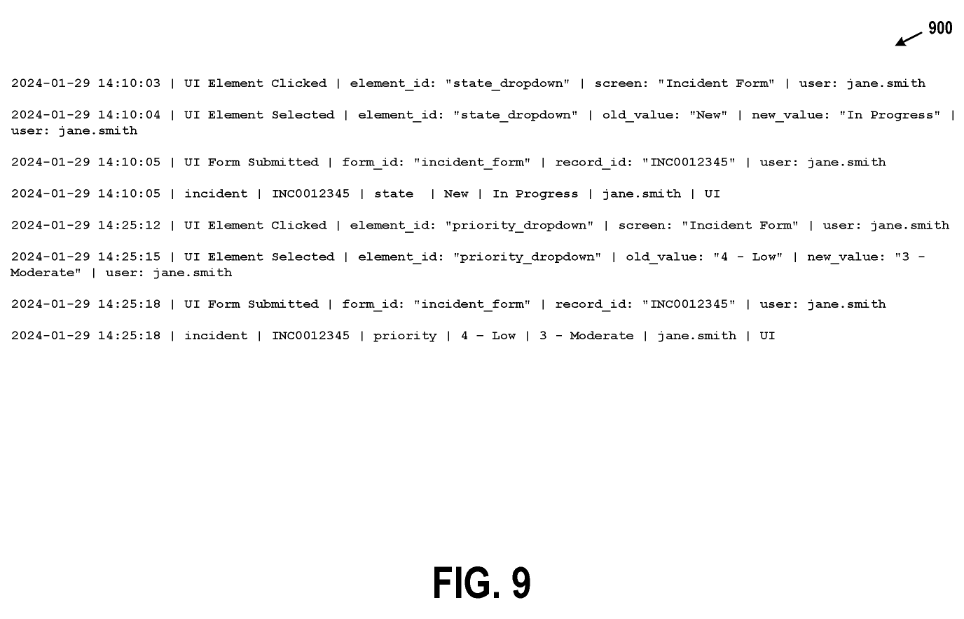

FIG. 9 depicts combined log 900, which is a merging of audit log excerpt 700 and UI interaction log 800. For sake of simplicity and presentation, only a few events are shown. Particularly, events relating to changing the state of the incident from New to In Progress and changing the priority of the incident from Low to Moderate are shown.

In general, integrating audit logs (which track backend database changes) with UI interaction logs (which record frontend user interactions) into a single combined log provides significant technical advantages for monitoring, troubleshooting, and system improvement. First, it enables end-to-end visibility by correlating user actions on the user interface (such as dropdown selections or button clicks) with database changes, allowing technicians to quickly trace modifications and diagnose whether updates were manual, automated, or system-triggered. This eliminates blind spots in change tracking, significantly reducing debugging time. Second, the integration improves performance optimization and user interface design by detecting inefficient user interface behaviors – such as users repeatedly submitting forms due to slow feedback – which can overload system resources with redundant database writes. By analyzing UI interactions alongside audit logs, workflows can be refined and unnecessary processor load reduced.

Moreover, combined log 900 can be used for identifying sequences of “interest” – sequences of events that indicate whether a procedure was performed as nominally expected, performed inefficiently (e.g., with retries or do-overs), generated errors or warnings, or failed to complete properly.

For example, in a user interaction with a series of one or more web forms, the user loading the first web form may be a logical (e.g., predefined) starting point, the user interacting with various combination of the forms (e.g., dropdown menus, text boxes, buttons) may be intermediate activities, and the user saving or submitting the final web form may be a logical (e.g., predefined) ending point. The resulting sequence of events represent the nominal performance of a procedure.

However, in practice the procedure can be performed in a non-nominal fashion. For instance, the final web form may never be submitted. Or, even if the final web form is submitted, the user may have spent a significant amount of time on the intermediate activities or carried out some of the intermediate activities two or more times. Each of these non-nominal sequences of events may indicate that a user is attempting to perform the procedure but is getting confused about how to carry it out or is otherwise being blocked from completing it for some reason.

Combined log 900 may also include indications of computing resource utilization due to the events (e.g., processor and/or memory utilization) and/or security warnings related to the events. Sequences including these indications (which may also be considered events) may also be examples of non-nominal performance of a procedure.

### D.ML Clustering

ML clustering step 608 may involve employing one or more supervised, semi-supervised, or unsupervised clustering models to identify sequences of interest and group together similar sequences. As noted, these sequences are made up of timestamped events in combined log 900 that represent the activities of one or more users toward a putative goal. In some sequences, the goal may be achieved (e.g., the completion of input to a multi-stage web-based form). In other sequences, the goal may not be achieved (e.g., steps are taken toward completion of the web-based form but it is never saved or submitted, or the steps taken toward a goal are repetitive, lengthy, subject to security warnings, use an undue amount of computing resources, or otherwise inefficient).

As combined log 900 may be quite lengthy (including tens of thousands, hundreds of thousands, or more of discrete events) and include a number of such sequences, an ML model may be employed to identify and group these sequences. In some cases, the ML model may include two or more discrete ML components (e.g., one to identify sequences and another to cluster the identified sequences). As noted above, the ML model could be supervised (e.g., trained with labeled input and output sequences to identify such sequences in combined log 900), semi-supervised (e.g., trained to recognize events in combined log 900 that represent the starting and ending points of procedures that are likely to relate to sequences), or unsupervised (able to infer sequences from patterns of events in combined log 900).

For example, the ML model may include a hidden Markov model (HMM). HMMs are useful for modeling sequences of events, especially when the underlying procedure that generates the events follows an implicit state-based structure. Notably, the events in combined log 900 are sequential in nature and exhibit hidden states (e.g., nominal behavior and failure modes). HMMs can learn these hidden states, then identify and cluster sequences of events based on their probabilistic associations. Such an HMM may require supervised training in the form of identification of a number of hidden states.

In another example, the ML model may include a recurrent neural network (RNN), an autoencoder, and/or possibly other deep learning techniques. Deep learning can be used to automatically identify patterns in events and group similar sequences of events into clusters. Advantageously, these techniques can operated in an unsupervised or semi-supervised fashion. Doing so may involve converting events in combined log 900 into vector representations (e.g., Word2Vec, FastText, or transformer-based embeddings in an n-dimensional semantic space). From these embeddings sequences can be identified – for instance, each sequence may begin with a pre-defined starting point of a procedure and may or may not end with an pre-defined ending point of a procedure. An RNN or autoencoder can be trained based on these vector embeddings (e.g., training a long short-term memory (LSTM) model, gated recurrent unit (GRU) model, or transformer-based model to identify sequences of events based on their probabilistic associations). These sequences can then be clustered using K-means or DBSCAN techniques, for instance (e.g., based on their proximities in the n-dimensional semantic space).

Regardless of the type of model or models employed, the sequences of events may be clustered. For example, a cluster of a nominal sequences may include sequences that began at a common starting point and ended at a common ending point. Another cluster of sequences may be formed for sequences that began at the same common starting point as the nominal cluster, but ended somewhere other than the common ending point. This cluster may represent procedures that were not completed for some reason. Yet another cluster of sequences may be formed for sequences that that began at the same common starting point as the nominal cluster, but exhibited inefficiencies (e.g., cycles of the same events, long delays between events, event indicating computing resource utilization or security warnings, etc.). This cluster may represent procedures that were not completed efficiently (the procedures may or may not have been completed, but they were performed inefficiently). Notably, some non-nominal sequences may end at the common ending point, but reach it in an inefficient fashion.

In some cases, clusters representing sequences that were completed nominally may be further analyzed and/or compared to sequences that were not completed and/or sequences that were performed inefficiently (e.g., involving more than a threshold number of events or a series of events representing one or more cycles). For a given nominal sequence, one or more non-nominal sequences (not completed or inefficiently performed sequences) relating to the same procedure may be identified. The ML model may perform this identification based on these sequences having the same or a similar starting point and including a similar series of events, for example.

Doing so may serve to identify procedures that have more than a threshold number or percentage of non-nominal sequences. For example, a given procedure may be carried out 1000 times by various users. If 990 of these result in nominal sequences, 6 result in incomplete sequences, and 4 result in inefficient sequences, then the procedure is performed nominally 99% of the time and non-nominally 1% of the time. This procedure may be one that most users are comfortable with and carry out as expected, and therefore the procedure needs no further attention. However, generating a formal workflow for this procedure may still be beneficial.

On the other hand, suppose that the given procedure was instead carried out nominally 700 times, did not complete 200 times, and completed inefficiently 100 times. In this situation, the procedure may be one that confuses users and could benefit from a formal workflow, a guided tour, or both.

As noted above, a non-nominal sequence could be completed inefficiently, for example, when a user goes back and forth between pages but eventually reach a final state of the procedure. Some users may follow a certain inefficient path because the user interface is poorly designed. Machine learning can also be employed to evaluate a completed non-nominal sequence and try to improve it if possible (e.g., by eliminating repetitions and loops). A workflow can then be generated with an alternative user interface configuration for a better and more efficient sequence.

### E.Selection of Sequences

Presentation for selection step 612 may involve a user being presented with, on a user interface, one or more clusters of sequences. The user may be given an option to generate a workflow and/or a guided tour for the procedures underlying these sequences. In some cases, the software platform may suggest which sequences are deemed to be the “best” candidates for selection, such as sequences representing procedures with relatively low rates of completion (e.g., below 90%, 70%, or 50%). Note that the threshold rate of completion below which a sequence is a candidate for selection may vary based on the importance of the underlying procedure. In some cases, the user interface may display the clusters in some fashion with different sequences located on the display based on the proximity in the semantic space to other sequences.

Alternatively, the selection of sequences for workflow and/or guided tour generation may occur automatically based on a configuration of the software platform. For example, the software platform may identify any workflow with a completion rate below a threshold value (e.g., below 90%, 70%, or 50%) and select this sequence for workflow and/or guided tour generation.

Regardless, any selected sequence may be transformed from the format of combined log 900 to a structured data format suitable for input to a workflow generator and/or a guided tour generator. More detail on these formats is below.

### F.Sequences for Workflow and Workflow Generation

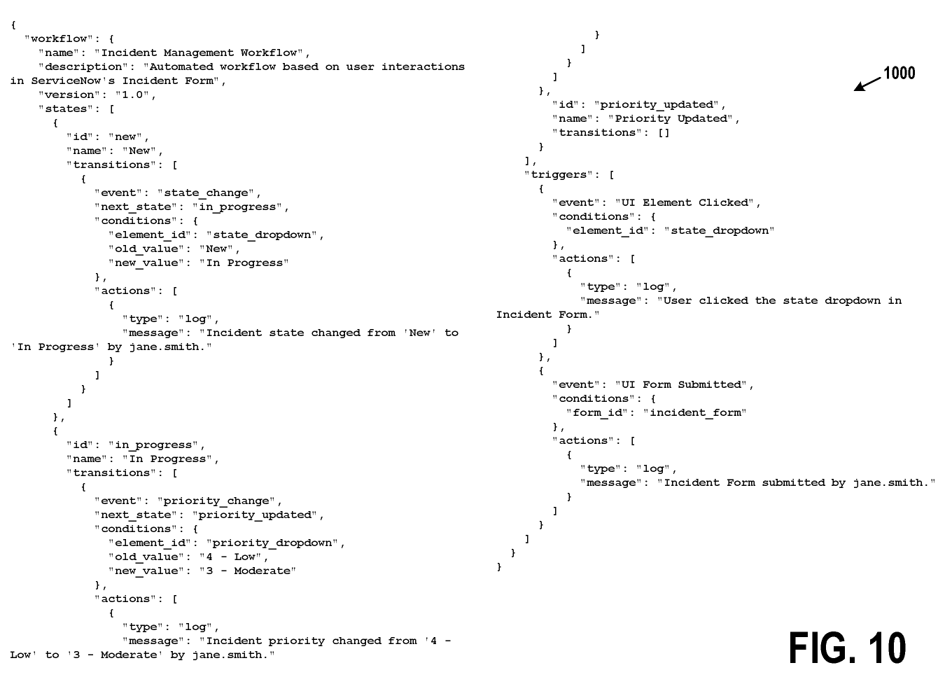

FIG. 10 depicts an example formatted representation 1000 of a selected sequence (e.g., one of sequences for workflow 614). Representation 1000 is of a JSON workflow definition file that corresponds to the sequence of combined log 900 (other formats than JSON may be used). Thus, representation 1000 includes several states, beginning with the New state, which transitions to In Progress when the user selects the In Progress state from the dropdown. Subsequently, the In Progress state transitions to Priority Updated when the priority is changed. The workflow also includes triggers that represent user interface interactions, such as when a user clicks on dropdown elements, as well as when an incident form is submitted. Representation 1000 may be provided to workflow generation step 616 in order to produce workflow 618.

Workflow generation step 616 may employ a workflow generator to processes a JSON workflow definition file. Given the workflow definition, the generator may parse and validate its contents, checking that the expected attributes – such as workflow name, version, states, transitions, and actions – are present and properly formatted. If any information is missing or incorrectly structured, the workflow generator may trigger an error-handling process, logging validation errors or providing feedback for correction.

Once validated, the workflow generator creates a new workflow object within a database table, assigning it a unique workflow ID and storing metadata such as its name, description, version, and owner. The workflow generator may then proceed to define workflow states and transitions. Each state may be assigned a state ID, display name, and possible transitions, while each transition specifies the triggering event, preconditions, and automated actions that can execute when the transition occurs.

To manage state changes, the workflow generator may register event listeners and triggers based on the JSON workflow definition file. These triggers can respond to user interactions (such as clicking dropdowns or submitting forms), database updates (such as field changes), or scheduled and API-driven events. For instance, if the JSON workflow definition file defines a transition where an incident’s state moves from New to In Progress, the generator creates an event listener that monitors changes to the incident state field of the incident, as stored in an incident database table.

In addition to managing transitions, the workflow generator may process workflow actions, mapping them to corresponding functionalities. These actions can include logging events, sending notifications, executing scripts, and/or updating various database records. Once the newly-created workflow is configured for deployment, the workflow generator may activate the workflow, enabling its real-time execution.

### G.Sequences for Guided Tour and Guided Tour Generation

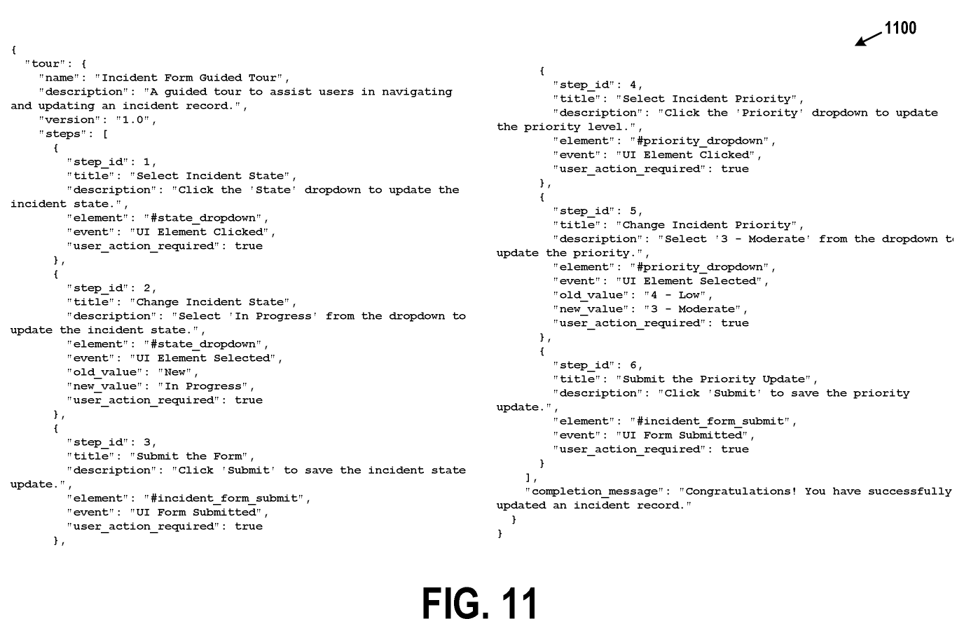

FIG. 11 depicts an example formatted representation 1100 of a selected sequence (e.g., one of sequences for guided tour 620). Representation 1100 is of a JSON file that corresponds to the sequence of combined log 900 (other formats than JSON may be used). Thus, representation 1100 guides the user to update the incident state from New to In Progress, directs the user to submit the form after making changes, instructs the user to update the incident priority from 4 - Low to 3 – Moderate”, and ends with a confirmation message once the form is successfully updated. Representation 1100 may be provided to guided tour generation step 622 in order to produce guided tour 624.

Guided tour generation step 622 may employ a guided tour generator configured to create interactive, step-by-step walkthroughs that help users navigate and interact with user interfaces. When provided with a JSON file representation of a guided tour, the guided tour generator can parse the structured data in this file to dynamically construct an in-platform experience. The guided tour generator may processes attributes from the JSON file, such as the tour name, description, version, and completion message, and store them in a database table for guided tours.

The guided tour generator may iterate through the steps defined in the JSON file, each of which corresponds to a distinct user interface interaction. For every step, it extracts attributes such as step ID, title, description, user interface element, event type, and user action. The guided tour generator then binds the guided tour steps to the specified user interface elements, e.g., using client-side API and DOM selectors, so that the tour highlights the correct user interface components when activated.

To that end, the guided tour generator may inject tooltip overlays, navigational cues, and instructional pop-ups at the designated user interface elements. These tooltips, cue, and pop-ups dynamically appear as the user interacts with the interface, guiding them through the required actions. If a step specifies a predefined condition, such as requiring an element’s value to change from 4 - Low to 3 - Moderate, the guided tour generator attaches an event listener that monitors state changes before allowing progression.

Once deployed, the guided tour execution logic can be managed through a guided tour service that tracks user progress and persists session state. When a user completes a guided tour, the software platform displays the completion message defined in the JSON file, confirming a successful walkthrough. Additionally, the software platform may be configured to log tour completion metrics for administrators to track guided tour engagement and effectiveness.

### VIII.Example Operations

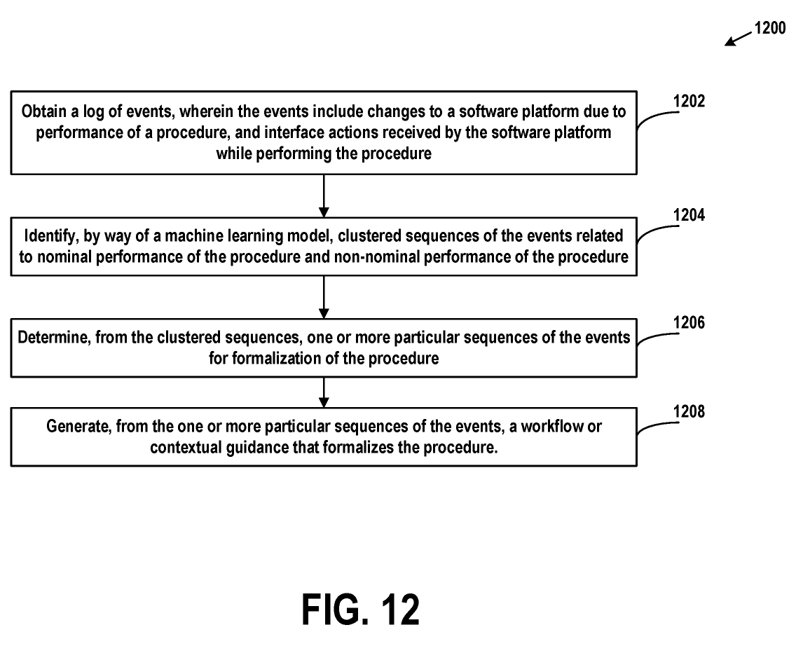

FIG. 12 is a flow chart 1200 illustrating an example embodiment. The process illustrated by FIG. 12 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 12 may be simplified by the removal of any one or more of the features shown therein. Further, these embodiments may be combined with features, aspects, and/or implementations of any of the previous figures or otherwise described herein.

Block 1202 may involve obtaining a log of events, wherein the events include changes to a software platform due to performance of a procedure, and interface actions received by the software platform while performing the procedure.

Block 1204 may involve identifying, by way of a machine learning model, clustered sequences of the events related to nominal performance of the procedure and non-nominal performance of the procedure.

Block 1206 may involve determining, from the clustered sequences, one or more particular sequences of the events for formalization of the procedure.

Block 1208 may involve generating, from the one or more particular sequences of the events, a workflow or contextual guidance that formalizes the procedure.

These aspects represent a technical improvement because formalization of an ad hoc procedure with a workflow or enhancement of the procedure with contextual guidance (e.g., a guided tour) results in reduced usage of computing resources. As noted elsewhere herein, each navigation of a procedure (e.g., actuations of user interface elements) requires processing, memory, network, and/or power capacity. If users or other entities are confused or unable to perform a procedure efficiently and correctly, more computing resources than necessary will be employed to carry out the procedure. On the other hand, use of workflows and contextual guidance reduce the likelihood of unnecessary navigation events and thus leads to less wastage of computing resources.

Some embodiments may further involve generating the log of events by combining a first log of the changes to the software platform and a second log of the interface actions, wherein the events in the log of events are ordered by timestamp.

In some embodiments, the changes to the software platform include writes to one or more databases tables.

In some embodiments, the interface actions include actuations of user interface components.

In some embodiments, determining the one or more particular sequences comprises: generating, for display, a representation of at least some of the clustered sequences; and receiving a selection of the one or more particular sequences for the formalization of the procedure.

In some embodiments, the display also includes: a first count of the clustered sequences related to nominal performance of the procedure and a second count of the clustered sequences related to non-nominal performance of the procedure; or a representation of a ratio between the second count and the first count.

In some embodiments, the workflow includes a state machine of nodes representing actions and transitions between the nodes, and wherein the workflow is initiated by specific triggers occurring on the software platform.

In some embodiments, the contextual guidance comprises an overlay system that dynamically interacts with a user interface to display information related to performing sub-tasks of the procedure.

Some embodiments may further involve executing one or more features of the workflow or the contextual guidance during a subsequent performance of the procedure.

In some embodiments, the clustered sequences include respective series of the events, wherein the respective series each have at least a threshold similarity with one another.

In some embodiments, the clustered sequences related to nominal performance of the procedure each begin at a common starting point and each end at a common ending point.

In some embodiments, at least some of the clustered sequences related to non-nominal performance of the procedure each begin at the common starting point but do not end at the common ending point.

In some embodiments, at least some of the clustered sequences related to non-nominal performance of the procedure each were performed inefficiently in terms of a number of events in the clustered sequences or cycles of events in the clustered sequences.

In some embodiments, at least some of the clustered sequences related to non-nominal performance of the procedure caused warnings or errors related to their usage of computing resources or related to security violations.

### IX.Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a log of events, wherein the events include changes to a software platform due to performance of a procedure, and interface actions received by the software platform while performing the procedure;
identifying, by way of a machine learning model, clustered sequences of the events related to nominal performance of the procedure and non-nominal performance of the procedure;
determining, from the clustered sequences, one or more particular sequences of the events for formalization of the procedure; and
generating, from the one or more particular sequences of the events, a workflow or contextual guidance that formalizes the procedure.

2. The method of claim 1, further comprising:
generating the log of events by combining a first log of the changes to the software platform and a second log of the interface actions, wherein the events in the log of events are ordered by timestamp.

3. The method of claim 1, wherein the changes to the software platform include writes to one or more databases tables.

4. The method of claim 1, wherein the interface actions include actuations of user interface components.

5. The method of claim 1, wherein determining the one or more particular sequences comprises:
generating, for display, a representation of at least some of the clustered sequences; and
receiving a selection of the one or more particular sequences for the formalization of the procedure.

6. The method of claim 5, wherein the display also includes:
a first count of the clustered sequences related to nominal performance of the procedure and a second count of the clustered sequences related to non-nominal performance of the procedure; or
a representation of a ratio between the second count and the first count.

7. The method of claim 1, wherein the workflow includes a state machine of nodes representing actions and transitions between the nodes, and wherein the workflow is initiated by specific triggers occurring on the software platform.

8. The method of claim 1, wherein the contextual guidance comprises an overlay system that dynamically interacts with a user interface to display information related to performing sub-tasks of the procedure.

9. The method of claim 1, further comprising:
executing one or more features of the workflow or the contextual guidance during a subsequent performance of the procedure.

10. The method of claim 1, wherein the clustered sequences include respective series of the events, wherein the respective series each have at least a threshold similarity with one another.

11. The method of claim 1, wherein the clustered sequences related to nominal performance of the procedure each begin at a common starting point and each end at a common ending point.

12. The method of claim 11, wherein at least some of the clustered sequences related to non-nominal performance of the procedure each begin at the common starting point but do not end at the common ending point.

13. The method of claim 11, wherein at least some of the clustered sequences related to non-nominal performance of the procedure each were performed inefficiently in terms of a number of events in the clustered sequences or cycles of events in the clustered sequences.

14. The method of claim 11, wherein at least some of the clustered sequences related to non-nominal performance of the procedure caused warnings or errors related to their usage of computing resources or related to security violations.

15. A non-transitory computer-readable medium, having stored thereon program instructions that, upon execution by a computing system, cause the computing system to perform operations comprising:
obtaining a log of events, wherein the events include changes to a software platform due to performance of a procedure, and interface actions received by the software platform while performing the procedure;
identifying, by way of a machine learning model, clustered sequences of the events related to nominal performance of the procedure and non-nominal performance of the procedure;
determining, from the clustered sequences, one or more particular sequences of the events for formalization of the procedure; and
generating, from the one or more particular sequences of the events, a workflow or contextual guidance that formalizes the procedure.

16. The non-transitory computer-readable medium of claim 15, wherein the clustered sequences related to nominal performance of the procedure each begin at a common starting point and each end at a common ending point.

17. The non-transitory computer-readable medium of claim 16, wherein at least some of the clustered sequences related to non-nominal performance of the procedure each begin at the common starting point but do not end at the common ending point.

18. The non-transitory computer-readable medium of claim 16, wherein at least some of the clustered sequences related to non-nominal performance of the procedure each were performed inefficiently in terms of a number of events in the clustered sequences or cycles of events in the clustered sequences.

19. The non-transitory computer-readable medium of claim 16, wherein at least some of the clustered sequences related to non-nominal performance of the procedure caused warnings or errors related to their usage of computing resources or related to security violations.

20. A system comprising:
one or more processors; and
memory, containing program instructions that, upon execution by the one or more processors, cause the system to perform operations comprising:
obtaining a log of events, wherein the events include changes to a software platform due to performance of a procedure, and interface actions received by the software platform while performing the procedure;
identifying, by way of a machine learning model, clustered sequences of the events related to nominal performance of the procedure and non-nominal performance of the procedure;
determining, from the clustered sequences, one or more particular sequences of the events for formalization of the procedure; and
generating, from the one or more particular sequences of the events, a workflow or contextual guidance that formalizes the procedure.
